(19) United States
(12) Patent Application Publication
(10) Pub. No.: US 2020/0096327 A1
(43) Pub. Date: Mar. 26, 2020

(54) THREE-DIMENSIONAL SCANNING SYSTEM FOR A VARIETY OF ENVIRONMENTS

(71) Applicant: QISDA CORPORATION, Taoyuan City (TW)

(72) Inventors: Po-Fu Wu, New Taipei City (TW); Chuang-Wei Wu, Taipei City (TW)

(21) Appl. No.: 16/558,149

(22) Filed: Sep. 1, 2019

(30) Foreign Application Priority Data
Sep. 21, 2018 (CN) 201811106624.6

(51) Int. Cl. G01B 11/25

(52) U.S. Cl. CPC G01B 11/2518; G01B 11/254

(57) ABSTRACT

A three-dimensional scanning system includes a projection module, an image capturing module, and a reflector. The projection module includes a light source and a pattern generator. The light source provides a short-wavelength infrared light beam. The pattern generator receives the short-wavelength infrared light beam to project a predetermined pattern. The image capturing module captures the image formed by the predetermined pattern on an object to be scanned. The reflector reflects the short-wavelength infrared light beam to project the predetermined pattern on the object, and reflects the short-wavelength infrared light beam reflected by the object so the image capturing module can capture the image.

### BACKGROUND OF THE INVENTION

### 1. Field of the Invention

The present invention is related to a three-dimensional scanning system, and more particularly to a three-dimensional scanning system for a variety of environments.

### 2. Description of the Prior Art

A scanning device can be used to create three-dimensional models of objects and can be applied in many different fields. For example, an animator can use a scanning device to build a three-dimensional model of an object to reduce the time for manual drawing. Also, for example, a dental modeler can use a scanning device to build a three-dimensional model of a patient's teeth to make a denture suitable for the patient. In the prior art, the scanning device can emit a projection beam having a fixed pattern to the object to be scanned, and build the three-dimensional model of the object according to the pattern presented by the light reflected by the object. Since the surface of the object may have a special pattern or texture, the pattern derived from the reflection of the object may be different from the original fixed pattern. Therefore, the scanning device can obtain the three-dimensional model of the object according to the difference between the two patterns.

In the prior art, the scanning device scans the object with visible light, so the result of the scanning is usually affected by the environment in which the scanning device is located, causing distortion or error in measurement. For example, since a person's oral temperature and humidity are high, the lens of the scanning device may easily fogged up, making it difficult for the scanning device to capture a clear image and to obtain the characteristics of the tooth. In addition, there are often irregular slits in the joint between the teeth and the gums, commonly referred to as the gingival sulcus. Since the gingival sulcus often contains liquids such as saliva, water, blood, or medicine, the sulcus may be misjudged as a platform due to the light refraction of the liquids when scanning through visible light, causing errors and distortions in the scanning result.

### SUMMARY OF THE INVENTION

One embodiment of the present invention discloses a three-dimensional scanning system. The three-dimensional scanning system includes a projection module, an image capturing module, and a reflector.

The projection module includes a light source and a pattern generator. The light source provides a short-wavelength infrared light (SWIR) beam. The pattern generator receives the short-wavelength infrared light beam to project a predetermined pattern. The image capturing module captures an image formed by the predetermined pattern on an object to be scanned. The reflector reflects the short-wavelength infrared light beam to project the predetermined pattern on the object, and reflects the short-wavelength infrared light beam reflected by the object so as to enable the image capturing module to capture the image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a three-dimensional scanning system according to one embodiment of the present invention.

FIG. 2 shows a three-dimensional scanning system according to another embodiment of the present invention.

### DETAILED DESCRIPTION

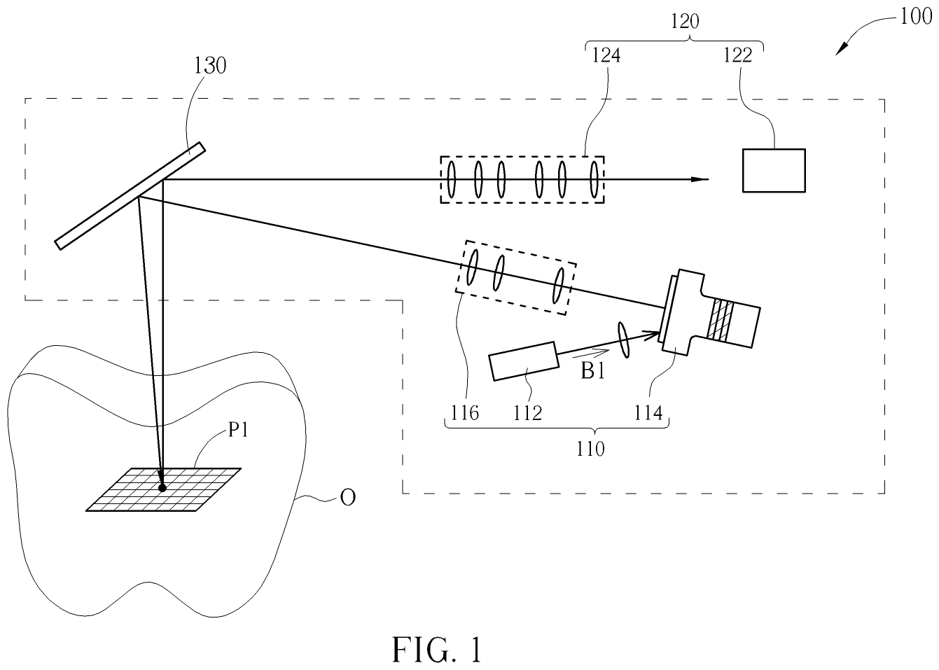

FIG. 1 shows a three-dimensional scanning system 100 according to one embodiment of the present invention. The three-dimensional scanning system 100 includes a projection module 110, an image capturing module 120, and a reflector 130.

The projection module 110 includes a light source 112 and a pattern generator 114. The light source 112 can provide a short-wavelength infrared light (SWIR) beam B1. The pattern generator 114 can receive the short-wavelength infrared light beam B1 to project a predetermined pattern P1.

In some embodiments, the pattern generator 114 can include a digital micromirror device (DMD), a dynamic grating generator, or a static grating generator for projecting the predetermined pattern P1. In some embodiments, the predetermined pattern P1 can, for example, but not limited to a checkered pattern or other types of structured light patterns.

The reflector 130 can reflect the short-wavelength infrared light beam B1 to project the predetermined pattern P1 on the object O to be scanned, and reflect the short-wavelength infrared light beam B1 reflected by the object O so as to enable the image capturing module 120 to capture the image formed by the predetermined pattern P1 on the object O. In some embodiments, the projection module 110 can include a lens set 116. The lens set 116 can guide the predetermined pattern P1 projected by the short-wave infrared light beam B1 to the reflector 130, and the reflector 130 can further project the predetermined pattern P1 onto the surface of the object O to be tested. In addition, the image capturing module 120 can include an image sensor 122 and a lens set 124. The predetermined pattern P1 projected by the short-wave infrared beam B1 will again project onto the reflector 130 after being reflected by the object O, and will be guided by the lens set 124 to the image sensor 122, allowing the image sensor 122 to take the corresponding image.

Since the surface of the object O may include patterns or textures, the predetermined pattern P1 presented by the short-wavelength infrared light beam B1 may be distorted after being reflected by the object O. Therefore, the three-dimensional scanning system 100 can obtain the three-dimensional model of the object O by comparing the original version and distorted version of the predetermined pattern P1.

In addition, the short-wavelength infrared light beam B1 is invisible light, and the wavelength can be between 0.9 micrometers and 2.5 micrometers and is larger than the wavelength of the general visible light. Therefore, the short-wavelength infrared light beam B1 has a smaller variation when refracting in the liquid, and has a better penetrating ability in the mist. With the characteristics of short-wavelength infrared light, the three-dimensional scanning system 100 can be applied to a humid environment of the mouth. Furthermore, even when the gingival sulcus on the object O is covered by the liquid, the short-wavelength infrared light beam B1 can still penetrate the moisture and the liquid, and project the predetermined pattern P1 on the surface of the object O, allowing the image capturing module 120 to capture the image of the surface of the object O. Consequently, the three-dimensional scanning system 100 can greatly reduce errors and distortions compared to the prior art using the visible light for scanning.

In FIG. 1, the image sensor 122 of the image capturing module 120 can sense the short-wavelength infrared light beam B1. For example, the image sensor 122 can include a short-wavelength infrared light lens so the image capturing module 120 can capture the image formed by the predetermined pattern P1 on the object O for the following image analysis. However, in some other embodiments, the image capturing module can transform the short-wavelength infrared light into visible light, and capture the images with an image sensor capable of sensing the visible light beam.

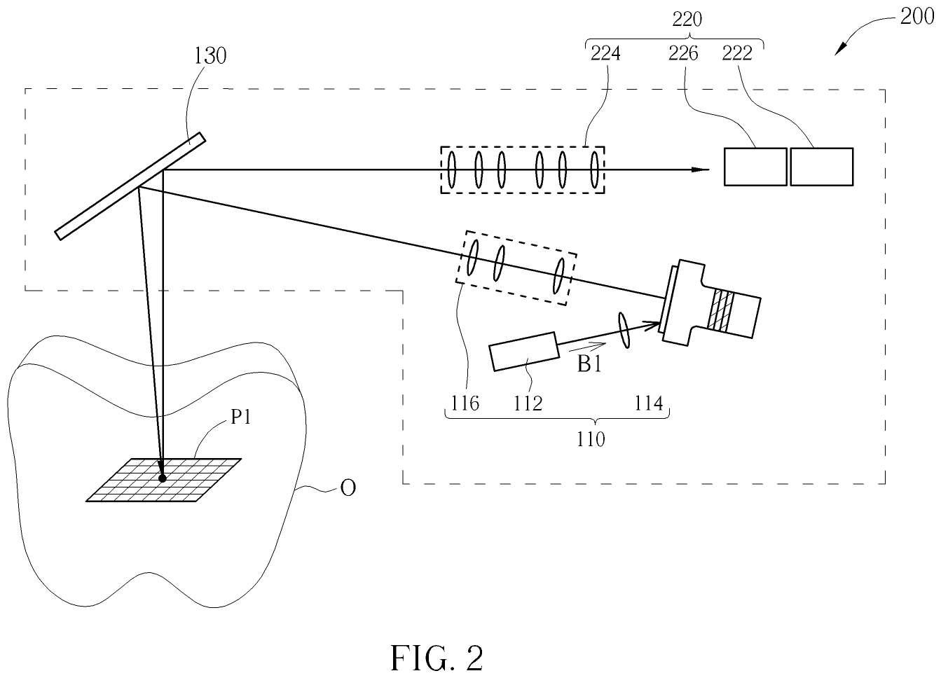

FIG. 2 shows a three-dimensional scanning system 200 according to another embodiment of the preset invention. The three-dimensional scanning system 200 and the three-dimensional scanning system 100 have similar structures and can be operated with similar principles. However, the image capturing module 220 of the three-dimensional scanning system 200 can include an image sensor 222, a lens set 224, and a wavelength converting component 226. The wavelength converting component 226 can employ the transforming device disclosed in U.S. Pat. No. 10,033,946B2 for receiving the short-wavelength infrared light beam B1 reflected by the object O, and transforming the short-wavelength infrared light beam B1 reflected by the object O into visible light. In this case, the image sensor 222 can be a general image sensor capable of sensing the visible light. Consequently, the relatively low-cost visible light image sensor 222 can be used to replace the image sensor 122 that senses the short-wavelength infrared light, so that the three-dimensional scanning system 200 can be more flexible in manufacturing and design. In some embodiments, the wavelength converting component 226 can be disposed between the object O and the reflector 130, between the reflector 130 and the lens set 224, or between the lens set 224 and the image sensor 222, depending on the design of the three-dimensional scanning system 200.

In summary, the three-dimensional scanning system provided by the embodiments of the present invention can project the predetermined pattern on the object to be scanned with the short-wavelength infrared light beam. Therefore, the predetermined pattern can penetrate through the moisture in the environment, and the error caused by the refraction of liquid on the surface of the object can also be reduced. That is, the three-dimensional scanning system provided by the embodiments of the present invention can be used in different environments while preserving the scanning accuracy, allowing the user to simplify the process of additional defogging or drying the object to be scanned before scanning.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A three-dimensional scanning system comprising:
a projection module comprising:
a light source configured to provide a short-wavelength infrared light (SWIR) beam; and
a pattern generator configured to receive the short-wavelength infrared light beam to project a predetermined pattern;
an image capturing module configured to capture an image formed by the predetermined pattern on an object to be scanned; and
a reflector configured to reflect the short-wavelength infrared light beam to project the predetermined pattern on the object, and reflect the short-wavelength infrared light beam reflected by the object so as to enable the image capturing module to capture the image.

2. The three-dimensional scanning system of claim 1, wherein the image capturing module comprises an image sensor configured to sense the short-wavelength infrared light beam.

3. The three-dimensional scanning system of claim 1, further comprising a wavelength converting component configured to receive the short-wavelength infrared light beam reflected by the object, and transform the short-wavelength infrared light beam into a visible light beam.

4. The three-dimensional scanning system of claim 3, wherein the image capturing module comprises an image sensor configured to sense the visible light beam.

5. The three-dimensional scanning system of claim 1, wherein a wavelength of the short-wavelength infrared light beam is between 0.9 μm and 2.5 μm.
